(19) United States
(12) Patent Application Publication
(10) Pub. No.: US 2018/0170317 A1
(43) Pub. Date: Jun. 21, 2018

(54) DEVICE FOR A SYSTEM FOR CONNECTING A BLADE TO A WIPER ARM

(71) Applicant: Valeo Systèmes d'Essuyage, Le Mesnil Saint Denis (FR)

(72) Inventor: Yvan Gironde, Issoire (FR)

(73) Assignee: Valeo Systèmes d'Essuyage, Le Mesnil Saint Denis (FR)

(21) Appl. No.: 15/842,046

(22) Filed: Dec. 14, 2017

(30) Foreign Application Priority Data
Dec. 15, 2016 (FR) 1662558

(51) Int. Cl. B60S 1/40; B60S 1/34

(52) U.S. Cl. CPC B60S 1/40; B60S 1/3452

(57) ABSTRACT

The invention relates to a device (26, 26′, 26″) for a system (16) for connecting a blade (12) to a wiper arm (14), said device, known as the first device, being configured so as to be secured to said blade (12) or to said arm (14) and including means of articulation (35, 35′, 35″) configured so as to cooperate with complementary means of articulation (60) of another device (30) of the connecting system (16), known as the second device, in order to define at least one means of attachment and pivoting about an axis (Y) of rotation of said first device (26, 26′, 26″) in relation to said second device (30), said means of articulation (35, 35′, 35″) of said first device (26, 26′, 26″) comprising a ball-and-socket connection of at least partially spherical, ellipsoidal or ovoidal shape, said first device (26, 26′, 26″) being characterized in that it comprises only a single ball-and-socket connection of at least partially spherical, ellipsoidal or ovoidal shape.

### TECHNICAL FIELD

The present invention relates to a device for a system for connecting a blade to a wiper arm.

### STATE OF THE ART

A motor vehicle is conventionally equipped with wipers in order to ensure washing of the windscreen and to avoid impairment of the driver's view of his environment. Said wipers generally comprise a driving arm, performing an angular reciprocal movement, and elongated blades, themselves carrying wiper blades, otherwise referred to as scraper blades, and made from an elastic material. Said blades rub against the windscreen and remove the water by moving it outside the field of view of the driver. The blades are produced in the form, either, in a classic version, of articulated mountings which hold the scraper blade at several discrete points, thereby imparting to it bowing enabling it to adopt the eventual curvature of the windscreen, or, in a more recent version known as “flat blade” (for “balai plat”), of a semi-rigid assembly, which supports the scraper blade over its entire length thanks to one or more bowing vertebrae allowing the blade to be applied to the windscreen without requiring the use of mountings.

In the two solutions, the blade is generally attached to the driving arm by a connection system including a connector and an adapter. The connector is a component that is generally permanently attached to the aforementioned semi-rigid assembly of the blade. The adapter is an intermediate adaptation component which permits the connection and the attachment of the connector to the driving arm. It is generally configured so as to be engaged in a head or end component in the form of a yoke of the driving arm.

Each of these devices (connector and adapter) comprises means of rotation configured so as to cooperate with complementary means of the other device, in order to define at least one axis of rotation of the devices, which is also an axis of rotation of the blade in relation to the arm. In the prior art, one of the devices, such as the connector, comprises a substantially cylindrical attached physical pivot axis, which defines the axis of rotation and which is received in a housing having a complementary shape of the other device.

Also known from the prior art FR2453757A1 is a wiper blade including articulated yokes including spherical means of articulation capable of fitting into housings implemented in complementary yokes, in such a way as to obtain an articulation in the absence of play between said yokes.

The invention proposes an alternative to these technologies, which is simple, efficient and economical, and permits, to the extent that is necessary, a greater freedom of movement at the level of the articulation compared with these prior arts.

### DISCLOSURE OF THE INVENTION

The invention proposes for this purpose a device for a system for connecting a blade to a wiper arm, said device, known as the first device, being configured so as to be secured to said blade or to said arm and including means of articulation configured so as to cooperate with complementary means of articulation of another device of the connecting system, known as the second device, in order to define at least one means of attachment and pivoting about an axis Y of rotation of said first device in relation to said second device, said means of articulation of said first device comprising a ball-and-socket connection of at least partially spherical, ellipsoidal or ovoidal shape, said first device being characterized in that it comprises only a single ball-and-socket connection of at least partially spherical, ellipsoidal or ovoidal shape.

The presence of a single ball-and-socket connection makes it possible to simplify the device of the prior art.

Furthermore, the presence of a single ball-and-socket connection makes it possible, if desired, to introduce and adjust longitudinal and/or lateral clearances between said first device and said second device, in order to be able to increase the angle of attack of the wiper blade in the reversing positions of the latter (known as the “fixed stop” position and the “opposing fixed stop” position, also referred to in English as the “inwipe” position and the “outwipe” position). For example, this avoids the need to have recourse to a twisted drive head at the level of an output shaft from the wiper motor or at the level of an output shaft from a wiper wheel box.

Said first device according to the invention may comprise one or a plurality of the following characterizing features, adopted singly or in combination one with the others:
said ball-and-socket connection of at least partially spherical, ellipsoidal or ovoidal shape exhibits in cross section an angular range (α, α′, α″) greater than 200°, or 250°, about a centre (A) of said ball-and-socket connection;
said ball-and-socket connection of at least partially spherical, ellipsoidal or ovoidal shape comprises a through opening extending around said pivot axis (Y);
said first device comprises guidance means configured so as to cooperate with said second device in order to guide the second device in rotation about said axis (Y), said guidance means preferably being independent of the means of articulation;
said first device comprises locking means configured so as to cooperate with said second device in order to allow only rotational displacements about said axis (Y), said locking means preferably being independent of the means of articulation;
said first device comprises guidance means and/or locking means which comprise at least one longitudinal wall that is substantially perpendicular to said axis of rotation (Y);
said longitudinal wall comprises or supports bearing or sliding protuberances, projecting and configured so as to cooperate with said second device;
said first device has an elongated shape;
said guidance means and/or locking means extend as far as at least one or each longitudinal extremity of said first device;
said guidance means and/or locking means comprise at least one longitudinal wall that is substantially perpendicular to said axis of rotation;
said first device comprises means of attachment to at least one element of the blade or of the arm;
said first device is a connector configured so as to be secured directly to said blade or an adapter configured so as to be secured directly to said arm.

The present invention also relates to a system for connecting a blade to a wiper arm, said system comprising a first device according to any one of the preceding definitions and a second device according to any one of the preceding definitions.

According to one variant embodiment, said connecting system permits three degrees of freedom (or three possibilities of rotation) of the second device on said first device.

According to another variant embodiment, said connecting system permits two degrees of freedom (or two possibilities of rotation) of the second device on said first device.

According to yet another variant embodiment, said connecting system permits only a single degree of freedom (or a single possibility of rotation) of the second device on said first device.

Advantageously, said first device is a connector configured so as to be secured to said blade, in particular to one or a plurality of vertebrae for stiffening of the blade.

Preferably, the means of rotation of the first device are mounted in complementary means of the second device by snap-in engagement.

The present invention further relates to a wiper blade, characterized in that it comprises or supports a first device or a system according to any one of the preceding definitions.

### DESCRIPTION OF THE FIGURES

The invention will be more readily appreciated, and other details, characterizing features and advantages of the invention will emerge from a perusal of the following description, which is provided by way of non-exhaustive example, with reference to the accompanying drawings, in which:

FIG. 1 is a partial schematic view in perspective of a wiper, said wiper including a wiper blade, a driving arm of the blade, and a system for connecting the blade to the arm,

FIG. 2 is an enlarged schematic view in perspective of the different elements of the connecting system according to one embodiment of the invention,

FIG. 3 is another schematic view in perspective of a first device according to the first embodiment of the invention,

FIG. 4 is a schematic view from the side of the device in FIG. 3,

FIG. 5 is a schematic view from above of the device in FIG. 3,

FIG. 6 is a schematic view from the side of a first variant of the first device in FIG. 3,

FIG. 7 is a schematic view from the side of a second variant of the first device in FIG. 3,

FIG. 8 is a schematic view from above of the device in FIG. 7,

FIG. 9 is a schematic view in perspective and from above of a second device according to the invention,

FIG. 10 is a schematic view in perspective and from above of the second device in FIG. 9,

FIG. 11 is a view in cross section according to a longitudinal median vertical plane of the device in FIG. 9.

### DETAILED DESCRIPTION

It should be noted that the figures disclose the invention in a detailed manner in order to implement the invention, said figures of course being capable, if necessary, of serving for the better definition of the invention.

In the following description, the designations longitudinal or lateral relate to the orientation of the wiper blade or of the driving arm, otherwise referred to as the wiper arm. The longitudinal direction corresponds to the principal axis of the wiper blade or of the wiper arm in which it extends, whereas the lateral orientations correspond to concurrent straight lines, that is to say lines which intersect the longitudinal direction, in particular lines perpendicular to the longitudinal axis of the wiper blade or of the wiper arm in its plane of rotation. In the case of the longitudinal directions, the designations external (or front) or internal (or rear) are determined in relation to the point of attachment of the wiper blade on the wiper arm, the designation internal corresponding to the area where the wiper arm and a half-blade extend. Finally, the directions referred to as upper or lower correspond to orientations that are perpendicular to the plane of rotation of the wiper blade on the windscreen, the designation lower including the plane of the windscreen.

Identical numerical references designate elements that are similar from one figure to the other, and the prime symbol (′) is used to designate variants of the same element in different embodiments.

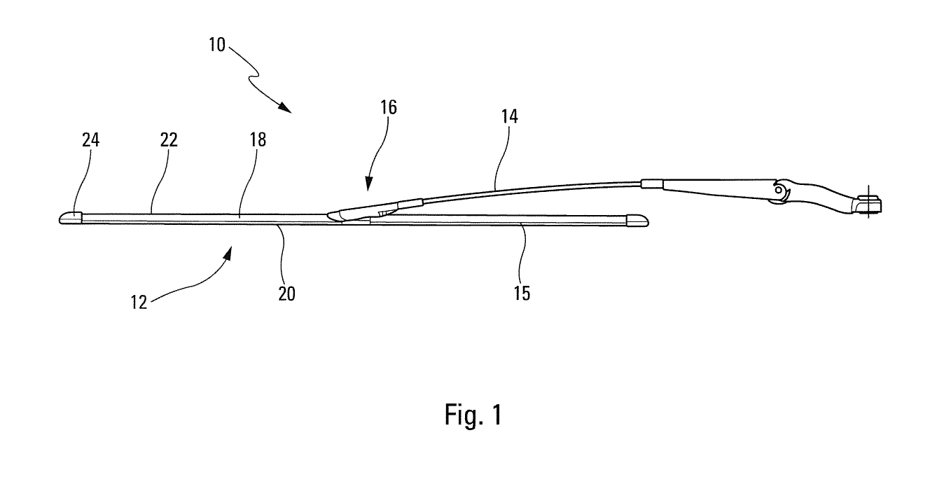

FIGS. 1-5 and 9-11 represent a first embodiment of the invention.

Reference is made initially to FIG. 1, which depicts a wiper 10 in its entirety, said wiper 10 including a wiper blade 12, a wiper arm 14 (partially represented) for driving the wiper blade 12, and a system 16 for connecting the wiper blade 12 to the wiper arm 14.

The wiper arm 14 represented here is an arm of the “Pinch Tab” type that is familiar to a person skilled in the art and is best described in document EP1565359 A1. Other types of arm may naturally be utilized within the context of the present invention.

The wiper arm 14 is intended to be driven by a motor in order to describe an angular reciprocal movement permitting the removal of water and any other undesirable elements covering the windscreen.

The wiper blade 12 is preferably of the flat blade type. It comprises, for example, a longitudinal body 18, a wiper blade 20 integrally formed with the longitudinal body 18 or attached thereto, for example made of rubber, and at least one vertebra 15 which stiffens the blade 20 and benefits its application to the windscreen.

The body 18 of the wiper blade 12 may advantageously include an upper aerodynamic deflector 22 intended to improve the function of the wiper, the purpose of said deflector 22 being to improve the pressing of the blade on the windscreen and thus the aerodynamic performance of the wiper.

The wiper blade 12 may comprise in addition end fittings 24 for the anchorage of the blade 20 and/or of the vertebra 15 on the body 18, said end fittings 24 being situated at each of the longitudinal extremities of the body 18.

The body 18 of the blade may also be implemented in two parts, which are disposed substantially end to end and are connected to each other by an intermediate device 26, in this case being a connector, which is part of the connecting system 16. Said parts may be independent of each other or connected together by a median part of the body 18, defined by a partial cut-out in the body 18. In this case, the blade 20 is generally attached to the longitudinal body 18.

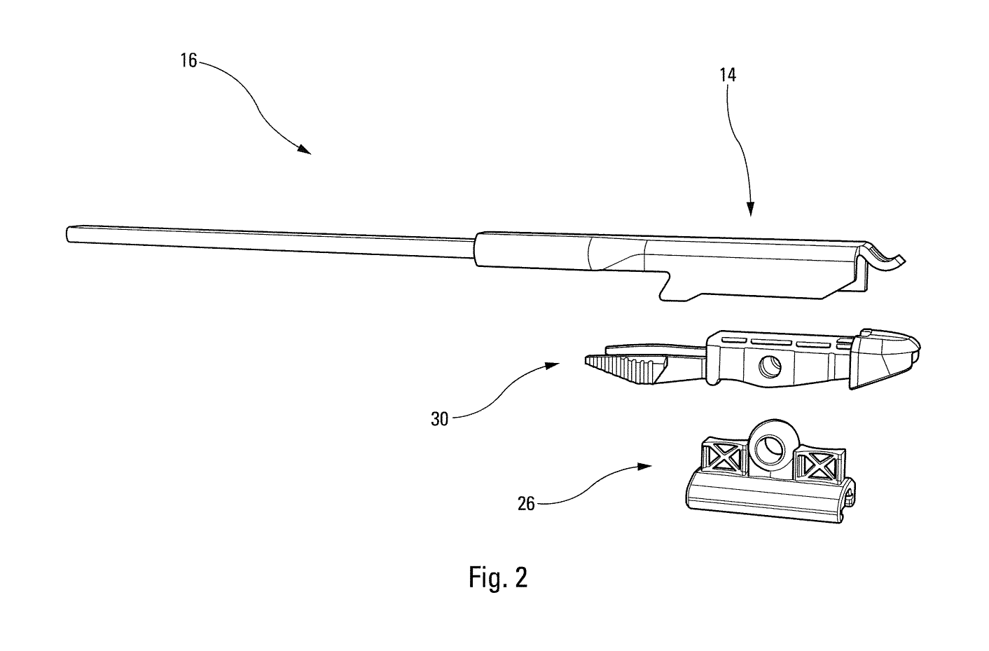

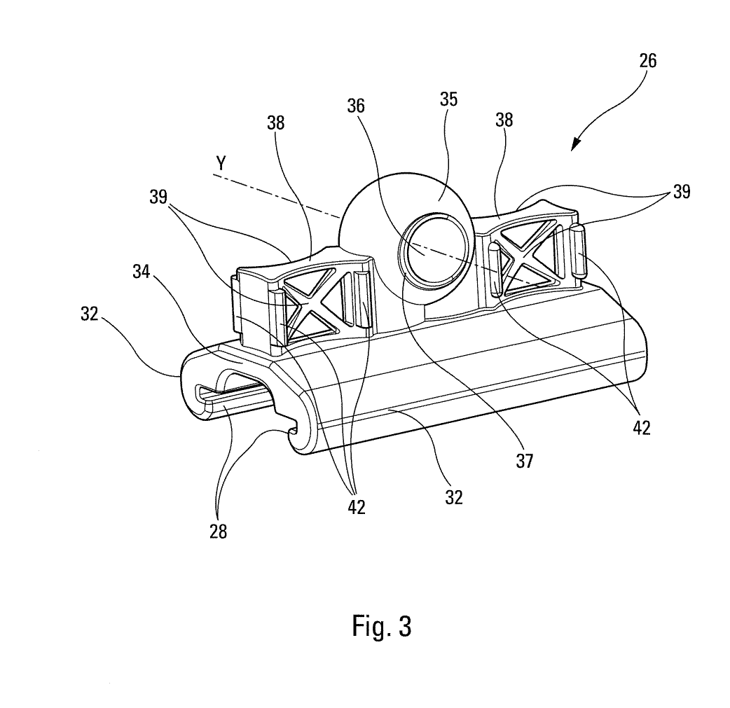

Reference is now made to FIGS. 2 to 5. The device 26 according to the invention, known as the first device, in this case being a connector, is generally attached to the blade between the two parts of the body 18 and may comprise means of connection to these parts. The connector 26 may also comprise means of attachment to the one or more vertebrae 15 for stiffening of the blade. It may thus comprise lower grippers 28 defining longitudinal grooves for receiving, in general by sliding, lateral longitudinal end sections of the one or more vertebrae 15, as is evident in FIG. 3. The device 26 is preferably configured so as to be permanently attached to the wiper blade 12.

The connecting system 16 comprises in addition a second device 30, in this case being an adapter, which is configured in order to be attached to the wiper arm 14 and which is mounted on the first device 26 in such a way as to retain at least one degree of freedom by pivoting about an axis of rotation Y which is a transversal axis substantially perpendicular to the longitudinal axis of the wiper blade 12. Said degree of freedom allows pivoting of the wiper blade 12 in relation to the wiper arm 14 and thus permits the blade 12 to follow the curvature of the windscreen in the course of its displacements.

This degree of freedom is achieved thanks to means of rotation of the first device 26 which are configured so as to cooperate with complementary means of the second device 30 in order to define said axis of rotation Y.

According to the invention, the means of rotation of the first device 26 comprise a single ball-and-socket connection and not simply a physical axis of cylindrical form, or a plurality of ball-and-socket connections, as in the prior art.

The first device or connector 26 in FIGS. 1 to 5 has a generally elongated form in the longitudinal direction of the wiper blade 12. It comprises two lower lateral walls 32 connected together at their respective upper extremity by a transverse wall 34 that is substantially perpendicular to the lateral extremities of the walls 32. The walls 32, 34 in this case have an elongated form in the longitudinal direction. The walls 32 support or comprise the aforementioned grippers 28.

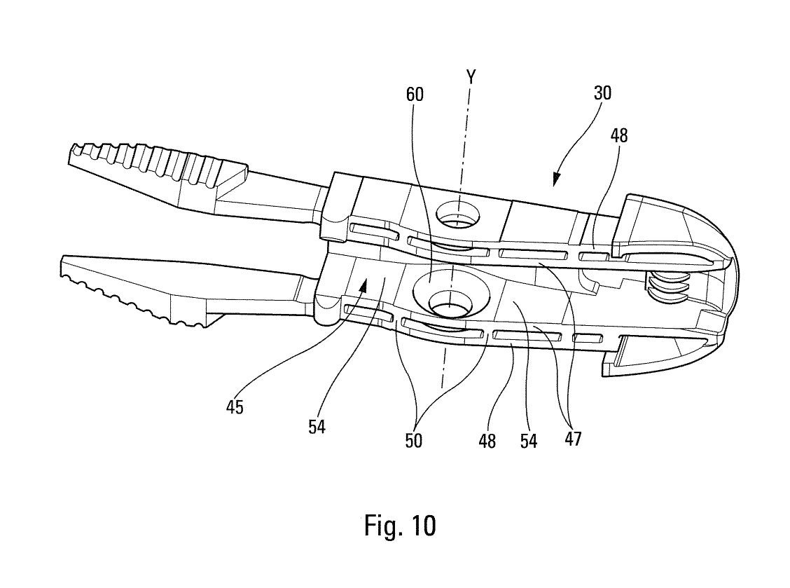

The first device 26 comprises a ball-and-socket connection of at least partially spherical, ellipsoidal or ovoidal shape, which is formed in this case by a spherical body 35, said body 35 being intended to be engaged, preferably by snap-in engagement, in a recess 60 (evident in FIG. 10) of complementary shape of the adapter 30.

The spherical body 35 in this case is integral with the wall 34, and is situated substantially in the middle of the upper part of the connector 26.

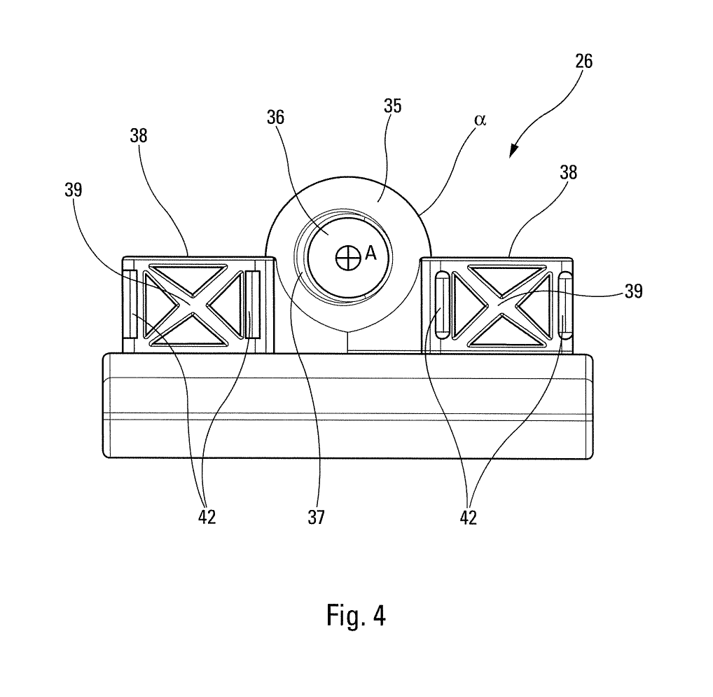

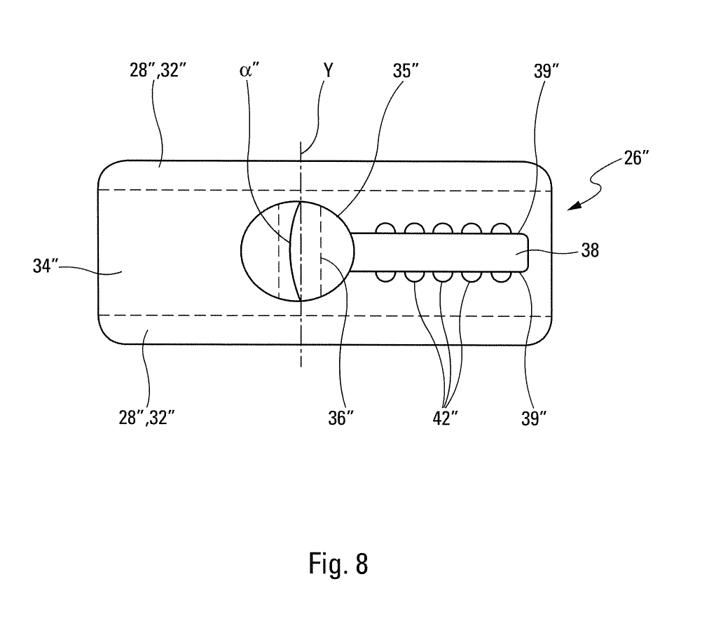

As evident in the first embodiment and in particular in FIG. 4, the body 35 in this case defines a portion of a central sphere A. The body 35 exhibits in cross section an angular range α of 180° about the centre A, delimited in part by the upper faces of the locking means and guidance means 38 described below. Said angular range may be measured in a transverse median plane comprising the axis Y (as represented in FIG. 8, which illustrates a variant embodiment of the first device according to the invention), or may be measured in a longitudinal median plane perpendicular to the axis Y, as illustrated in FIGS. 4-6.

The body 35 in this case comprises a through opening 36 which extends along the axis Y. Said opening 36 has a substantially cylindrical shape and is configured so as to receive a cylindrical rod of an arm when the latter is of the side-locking type, for example of the “Side-Lock” type familiar to a person skilled in the art, and better described in application U.S. Pat. No. 6,553,607 BA.

The locking means and guidance means 38 comprise at least one, and preferably two, blocks that are integral with the upper wall 34. Said blocks, which are substantially parallelepipedic, extend towards the top at the front and at the rear of the body 35, and each comprises two lateral faces 39. The lateral faces 39 comprise protuberances 42 intended to cooperate by sliding with corresponding means 54 of the second device 30 (evident in FIG. 10) in order, on the one hand, to allow and to guide the pivoting of the first device 26 in relation to the second device about the axis Y, and, on the other hand, to cooperate by bearing against or abutment with the corresponding means 54 of the second device 30 in order to limit or prevent unwanted displacements of the first device 26 in relation to the second device about the centre A, such as displacements about the longitudinal axis of the blade, for example.

The means 38 and the body 35 are aligned longitudinally in this case, one behind the other in the longitudinal median plane.

The assembly of the wiper blade 12 on the wiper arm 14 may be realized simply by presenting the connector 26 secured to the blade 12 directly below the adapter 30 secured to the arm 14, and by then displacing the connector in translation towards the adapter in a direction that is substantially perpendicular to the longitudinal axis of the blade, until the body 35 engages by snap-in engagement in the complementary means 60 of the adapter 30 (evident in FIG. 10) and until the means 38 engage in the housing 45 of the adapter 30.

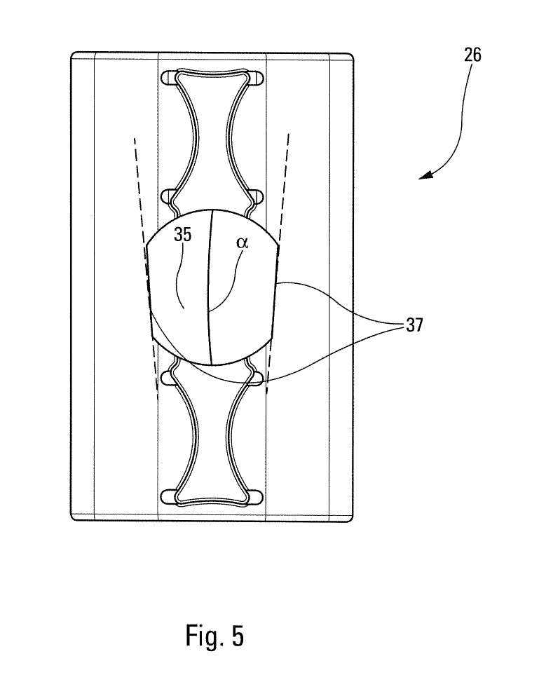

FIG. 5 represents a schematic view from above of the first device 26 of the first embodiment of the invention. As is evident in this Figure and in FIGS. 3 and 4, the opening 36 is preferably delimited on each lateral face of the body 35 by a peripheral edge comprising a flat spot 37. Each flat spot 37 is disposed in such a way that the width of the spherical body 35 increases from the front towards the rear of the first device 26, at the level of the opening 36. In this way, the first device 26 may easily be assembled with the second device 30, by a linear translation movement of the spherical body 35 to the interior of the second device 30, until the snap-in engagement of the body 35 in complementary means 60 (evident in FIG. 10) of the second device 30. The reduced width of the front side of the spherical body 35 (evident in FIG. 5) thus proposes to facilitate the introduction of the latter into the second device 30. The present invention is not limited to a suchlike embodiment, however, and it is alternatively possible to have a first device 26 which is symmetrical in relation to a vertical median plane perpendicular to the longitudinal axis of the first device 26, that is to say symmetrical in relation to a plane comprising the axis of rotation Y.

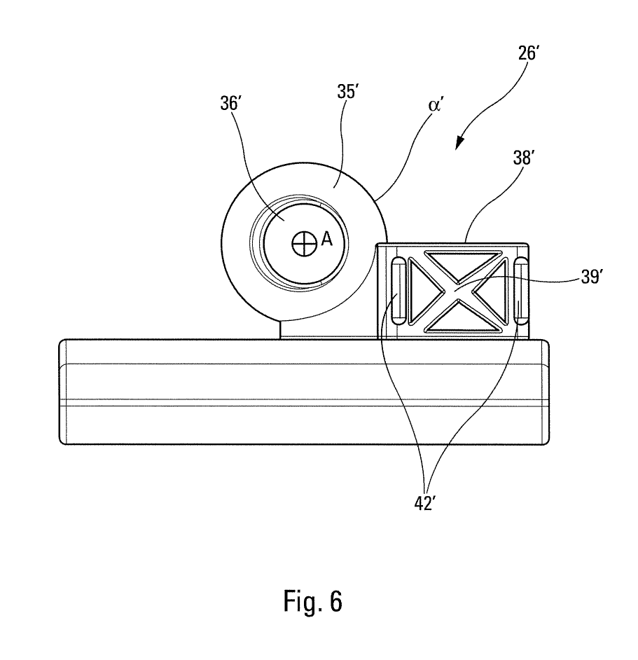

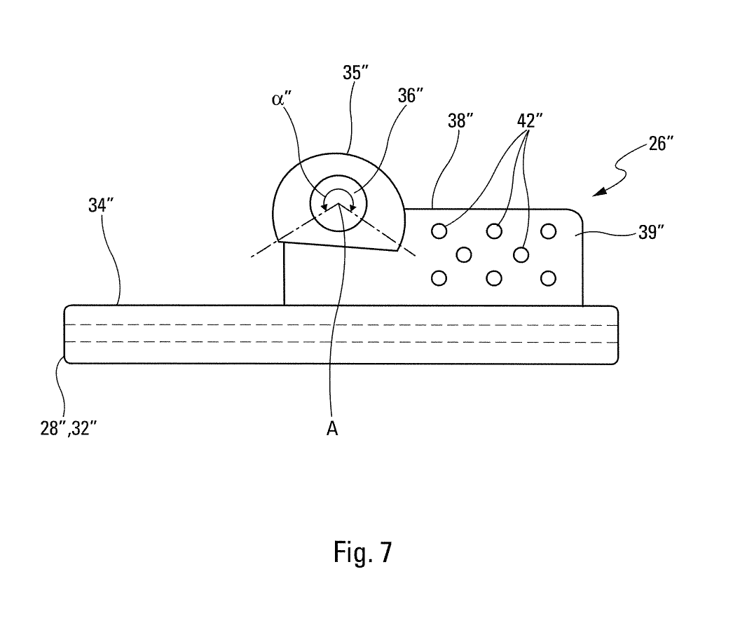

FIG. 6 represents another variant embodiment of the first device 26. According to this variant, the device 26′ differs from FIGS. 2 to 5 in that the means 38′ for locking and guidance comprise only a single block in the rear part of the device 26′, said block being substantially parallelepipedic in this case. As a result of the absence of a block at the front of the device 26′, the body 35′ in this case may have an angular range α′ about the centre A which is substantially greater than that of the device 26 in FIGS. 1 to 5, for example in the order of 250° in this case. FIGS. 7 and 8 represent yet another variant embodiment of the first device 26. As is evident in FIG. 8, the device 26″ comprises a body 35″ of ovoidal shape, and the means 38″ for locking and guidance comprise a single block 38″ at the rear of the body 35″. Said block 38″ comprises on its lateral faces protuberances 42″ in the form of pads or half-discs, configured so as to bear against the interior walls of the second device 30, in order to limit or prevent unwanted displacements of the connector 26″ in relation to the adapter 30 about the centre A, such as displacements about the longitudinal axis of the blade, for example. In addition, the surface of the protuberances 42″ in contact with the second device 30 is sufficiently small not to create excessively high frictional forces between the block 38″ and the device 30, which would interfere the rotation of the second device 30 in relation to the first device 26. The present invention is not restricted to a suchlike embodiment, however, and it is alternatively possible to have one or more blocks, of which the lateral faces 39″ are devoid of protuberances 42″ and are plane, for example.

The locking means and guidance means 38″ support the body 35″, which is connected directly to one of their longitudinal extremities.

The assembly of the wiper blade 12 on the wiper arm 14 may be produced in a simple manner, as described in the foregoing.

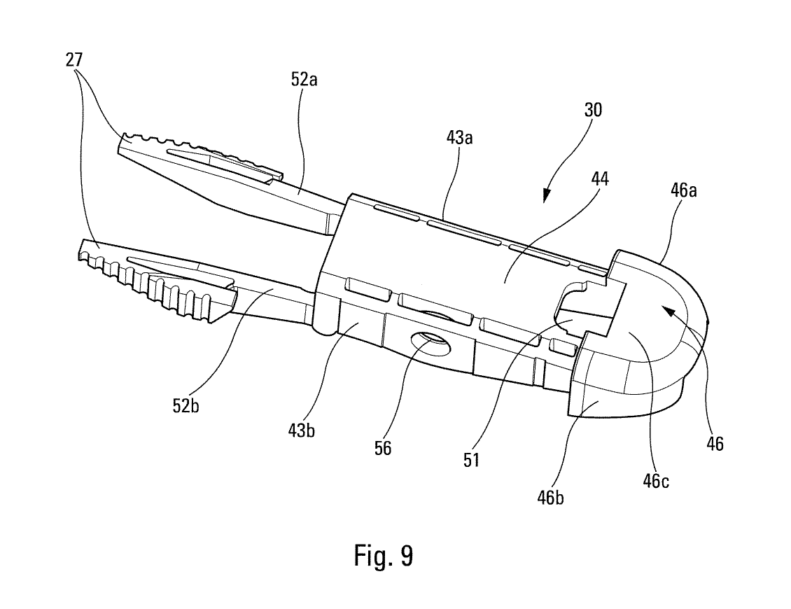

FIG. 9 represents the second device utilized in the invention.

In the first embodiment described in FIGS. 1-5 and 9-11, the second device 30 is an adapter of elongated shape along the longitudinal axis of the blade. It comprises a body including two lateral walls 43a, 43b that are substantially parallel to each other and to the axis A, and at a distance one from the other. Said walls 43a, 43b are connected to each other at their upper extremities by an upper transverse wall 44 that is substantially perpendicular to the walls 43a, 43b. Said upper transverse wall 44 may also be referred to as the base of the second device or adapter 30. The lateral and transverse walls 43a, 43b and 44 in this case have an elongated form in the longitudinal direction.

The lateral and transverse walls 43a, 43b, 44 of the adapter 30 define between them a longitudinal space or housing 45, in which the spherical, ellipsoidal or ovoidal 35 body of the first device 26 is intended to be mounted. The walls 43a, 43b in this case are of the double-skinned type and each include two skins, respectively internal 47 and external 48 (evident in FIG. 10), which are parallel and at a transverse distance one from the other. The skins are connected together by transverse rectilinear ribs 50, as can be seen in FIG. 10.

The body of the adapter 30 is connected at a first of its longitudinal extremities to a cowl or cladding, also referred to as the cap or head 46. Said head 46 has a lateral dimension greater than that of the body of the adapter and a height similarly greater than that of the body. The lateral walls 43a, 43b of the body of the adapter 30 thus stand back from or are offset in relation to the external lateral faces 46a, 46b of the head, and its upper wall 44 stands back from or is recessed in relation to an upper external face 46c of the head.

As is evident in FIG. 9, the upper wall 44 of the body of the adapter 30 comprises in addition an upper opening 51 for the engagement of a tongue of the “Pinch Tab” arm mentioned above. Said upper opening 51 in this case is formed in part in the head 46, at the rear extremity of the latter, and in part in the upper wall 44, at the front extremity of the latter. The opening 51 has a generally square or rectangular shape, for example, formed, for example, by two indentations in the form of a U, a first indentation in the form of a U being on the cap 46 and facing towards a second indentation in the form of a U situated on the upper wall 44.

The lateral walls 43a, 43b of the body continue towards the rear of the adapter 30, by means of elastically deformable legs 52a, 52b, which also extend longitudinally. Each lateral wall 43a, 43b is connected to a leg 52a, 52b, said legs 52a, 52b being parallel or inclined one in relation to the other, and being symmetrical in relation to a longitudinal median plane, substantially vertical, that is to say perpendicular to the upper wall 44 of the adapter. The free extremities of the legs 52a, 52b, which are situated on the side opposite the head 46, each support a projecting lateral push-button 27. Each leg 52a, 52b thus supports a push-button 27. The elastic deformations of the legs 52a, 52b in this case take place in a substantially horizontal longitudinal plane, that is to say substantially parallel to the upper wall 44. The legs 52a, 52b may be brought closer together by elastic deformation. The push-buttons 27 are configured so as to cooperate with notches in the “Pinch Tab” arm, as described in document EP1565359 A1.

The lateral walls 43a, 43b each comprise a through opening 56. The openings 56 in the walls 43a, 43b are substantially coaxial and in this case define the axis Y of pivoting of the adapter 30 on the connector 26, and accordingly that of the wiper blade 12 in relation to the wiper arm 14. The openings 56 in this case are of circular section. The openings 56 discharge at their external lateral extremities onto the external faces of the walls 43a, 43b, respectively, and at their internal lateral extremities into the housing 45.

As is evident in FIG. 9, the internal lateral faces facing towards the lateral walls 43a, 43b comprise cavities 60. Each lateral wall 43a, 43b comprises a cavity 60, the cavities 60 in this case being opposite one another and each extending in a direction towards the interior of the lateral walls 43a, 43b, that is to say in the direction of the space separating the two internal 47 and external 48 skins mentioned above. The cavities 60 are symmetrical in relation to a longitudinal median plane of the adapter, which is perpendicular to the upper wall 44. Each cavity 60 also exhibits a plane of symmetry passing through the axis Y.

In the example in FIGS. 9 to 11, the cavities 60 of the second device 30 exhibit a complementary shape to the ball and socket of partially spherical shape of the first device 26 in FIGS. 2-6.

If necessary, these cavities 60 will be respectively of concave, at least partially ellipsoidal or ovoidal shape complementary to the shape of the body 35, if the latter is ellipsoidal or ovoidal.

Each cavity 60 in this case is perforated and comprises in particular a transcurrent hole. Said hole in this case is formed by one of the aforementioned openings 56. Each cavity 60 is thus situated on the internal skin 47 of the lateral wall 43a or 43b in such a way as to be traversed by the opening 56 of said wall.

The axis of each opening 56, which is combined with the axis Y, is likewise combined with the axis of the corresponding cavity 60, so that the openings are centred in relation to the body 35. Each cavity 60 has an external diameter which represents about 60 to 80% of the height of the corresponding lateral wall 43a, 43b, measured in a substantially vertical direction perpendicularly to the upper wall 44.

The lateral walls 43a, 43b of the body of the adapter 30 in addition comprise on their internal lateral faces projecting means 54, which define supporting faces in the transverse direction. Certain of these projecting means 5, at least, are configured so as to be in contact with the protuberances 42 mentioned above or alternatively with the lateral faces 39, which may in particular be plane.

The projecting means in this case comprise strips of material 54 protruding on the internal lateral faces of the lateral walls 43a, 43b. The strips of material have an elongated form and extend longitudinally between the lower and upper longitudinal edges of the walls 43a, 43b.

The strips of material 54 define substantially parallel bearing faces. Said bearing faces in this case are substantially parallel to the external lateral faces of the walls 43a, 43b, as well as to the longitudinal axis of the adapter 30.

The adapter 30 described above is advantageously unitary, that is to say constituted by the same synthetic, plastic material. It may thus be manufactured in the course of a single moulding operation, in particular by injection.

The adapter 30 is attached to the connector 26 thanks to the body 35 and to the cavities 60 which form means of attachment of the adapter 30 to the connector 26, and means of pivoting of the adapter 30 in relation to the connector 26. The means of attachment are of the snap-in engagement type, the cavities 60 of the adapter 30 being intended to cooperate with the body 35 by snap-in engagement.

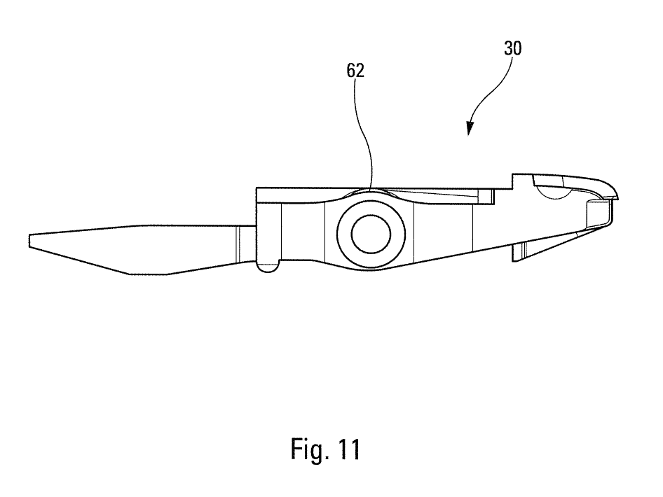

As evident in FIG. 11, the upper wall 44 of the second device or adapter 30 comprises a cavity 62 in which an upper part of the spherical body 35 may be received. This receiving cavity makes it possible to reduce the height of the assembly formed by the first 26 and second 30 devices when they are assembled with one another.

The connector 26 is so arranged as to be made integral, for example by crimping, with the wiper blade 12. The connector 26 may also provide a transport and distribution function of a liquid for washing the windscreen of the vehicle.

1. A first device for a system for connecting a blade to a wiper arm, said first device being configured to be secured to said blade or to said arm, the first device comprising:
means of articulation configured to cooperate with complementary means of articulation of a second device of the connecting system, to define at least one means of attachment and pivoting about an axis of rotation of said first device in relation to said second device,
said means of articulation of said first device comprising a ball-and-socket connection of at least partially spherical, ellipsoidal or ovoidal shape; and
only a single ball-and-socket connection of at least partially spherical, ellipsoidal or ovoidal shape.

2. The device according to claim 1, in which said ball-and-socket connection of at least partially spherical, ellipsoidal or ovoidal shape exhibits in cross section an angular range greater than 250°, about a centre of said ball-and-socket connection.

3. The device according to claim 2, in which said ball-and-socket connection of at least partially spherical, ellipsoidal or ovoidal shape comprises a through opening extending around said pivot axis.

4. The device according to claim 1, comprising guidance means configured so as to cooperate with said second device to guide the second device in rotation about said axis, said guidance means being independent of the means of articulation.

5. The device according to claim 1, comprising locking means configured so as to cooperate with said second device to authorize only rotational displacements about said axis, said locking means preferably being independent of the means of articulation.

6. The device according to claim 5, in which said guidance means and/or locking means comprise at least one longitudinal wall that is substantially perpendicular to said axis of rotation.

7. The device according to claim 6, in which said longitudinal wall comprises or supports bearing and sliding protuberances, projecting and configured to cooperate with said second device.

8. A system for connecting a blade to a wiper arm, said system comprising a first and a second device according to claim 1.

9. The connecting system according to claim 8, in which said first device is a connector configured so as to be secured to said blade.

10. The connecting system according to claim 8, in which the means of articulation of the first device are capable of being mounted in complementary means of the second device by snap-in engagement.

11. A wiper blade configured to support at least one device according to claim 1.

12. A wiper blade configured to support a system as claimed in claim 8.
